(19) United States
(12) Patent Application Publication
(10) Pub. No.: US 2003/0148879 A1
(43) Pub. Date: Aug. 7, 2003

(54) Technical ceramics made from combined municipal waste combustor ash

(75) Inventors: E. Larry Beaumont, Littleton, CO (US); Steve Meyer, Lakewood, CO (US)

Correspondence Address: HOFFMANN & BARON, LLP, 6900 JERICHO TURNPIKE, SYOSSET, NY, 11791, US

(73) Assignee: EAC Operations, Inc.

(21) Appl. No.: 10/342,893

(22) Filed: Jan. 15, 2003

Related U.S. Application Data
(60) Provisional application No. 60/348,815, filed on Jan. 15, 2002.

(51) Int. Cl. B01J 21/08

(52) U.S. Cl. 502/235; 502/240

(57) ABSTRACT

A ceramic material made from a precursor mixture including bottom ash particles recovered from a municipal solid waste combustor and fly ash particles recovered from combustion residual gases of a municipal solid waste combustor. In a process for manufacturing a technical ceramic from combined MWC ash, bottom ash particles are recovered from a municipal solid waste combustor and fly ash particles are recovered from combustion residual gases of a municipal solid waste combustor. The bottom ash particles are mixed with the fly ash particles to form a precursor combined ash mixture, which is cast to form the ceramic material.

### CROSS-REFERENCE TO RELATED APPLICATIONS

This application claims the benefit of U.S. Provisional Application No. 60/348,815, filed on Jan. 15, 2002.

### FIELD OF THE INVENTION

The present invention relates generally to ceramic materials and their method of manufacture, and more particularly to a technical ceramic made from combined municipal waste combustor bottom ash and fly ash (together referred to as “Combined MWC Ash”).

### BACKGROUND OF THE INVENTION

Technical ceramics are used in a variety of applications in such areas as electronics, telecommunications, semiconductors, and air pollution control. In such applications, technical ceramics often require carefully controlled blending of special constituents to maximize the desired material properties necessary for a given application. As a result, these ceramic materials are often expensive and limit the economic viability of a given product or application.

One example of the need for a lower-cost ceramic material is the solar power industry. The widespread application of photovoltaic technology is still hindered largely by the cost of the finished product. In the year 2000, residential applications typically require 20 to 30 solar cell panels at a cost of $350 to $450 per panel. Thus, the raw cost for the photovoltaics alone can be as high as $13,500, not including ancillary equipment and installation costs. A typical residential system costing more than $15,000 implies a payback period of six to ten years, far beyond the point where a consumer's individual investment in energy independence is compelling. A reduction in cost of these systems has been the subject of intensive research for many years, and achievement of this goal could unleash a major worldwide market.

Typical ceramic material production involves sintering of specialized mixtures of materials, such as silica, clay, feldspar and other additives known to provide certain strength versus density characteristics for special applications. Some ceramic materials, such as aluminum oxide-based ceramics, have excellent strength and heat resistance properties, but are also expensive and cannot be easily fabricated in large surface areas. Accordingly, it would be desirable to find a suitable low cost raw material for the manufacture of technical ceramics. Nothing could contribute more dramatically to a reduction in the cost of technical ceramics in certain markets than a reduction in cost of the materials making up the ceramic recipe.

Disposal of the combustion residues from municipal solid waste combustion has been a significant problem for many years. In particular, the ash materials obtained as a result of the combustion process within a municipal waste combustor (MWC) have heretofore had very limited practical use. Because they contain small amounts of heavy metals, the ash materials have achieved extremely limited acceptance despite significant developments in research and beneficial use applications. These applications include use as landfill cover, a road sub-base material, a filler for asphalt, and a filler for concrete. Even when extensive testing has demonstrated its safety, public acceptance, and the resulting granting of beneficial use determinations from regulatory agencies, has been slow.

As a result, current MWC ash management practice achieves at best a reduction in disposal cost, but MWC ash is still expensive to manage and dispose. At worst, millions of tons of this potentially valuable material are placed in landfills.

Recent past research and development focused on vitrification or sintering of MWC bottom ash, because the sintered product chemically and physically binds up the metals in the ash into a glassy, granular material that is durable and passes all environmental leaching tests for heavy metals. However, this product has very little market value and requires separate processing of fly ash for disposal.

The need for a viable, marketable, beneficial use for MWC ash has been well-documented in previous patents. For example, Penberthy (U.S. Pat. No. 4,299,611) proposed a method and apparatus for converting hazardous material to a harmless condition by depositing it on a molten target, which captures the hazardous material for environmentally sound disposal. This work represents early work in the area of sintering of waste material for disposal, but does not address MWC ash and is not suitable for beneficial use of the ash as a product.

Similarly, Kaneko et al. (U.S. Pat. No. 5,175,134) developed a ceramic tile using sludge slag. However, this approach does not address MWC ash and the process for producing the ceramic tile requires large amounts of clay and other filler materials.

Talmy et al. (U.S. Pat. No. 5,521,132) produced a ceramic material made from raw coal fly ash or raw MSW fly ash, but the ceramic material does not address Combined MWC Ash and requires large amounts of additives for proper mixing.

Golitz et al. (U.S. Pat. No. 5,583,079) also produced a ceramic material made of glass, fly ash, and clay binder. However, this patent does not mention MWC ash and requires large amounts of clay to achieve good material characteristics.

Hnat et al. (U.S. Pat. No. 5,935,885) discloses a process for manufacturing ceramic tiles from MWC fly ash. This process requires carefully controlled additives and MWC bottom ash is not covered.

Finally, Lee et al. (U.S. Pat. No. 6,342,461) utilizes MWC fly ash only and large amounts of clay additives to produce a ceramic material. Again, this material does not address Combined MWC Ash and requires homogenous mixing with other additives.

Accordingly, it would be desirable to provide a low cost ceramic material having excellent strength and heat resistant properties that can be used as a technical ceramic. It would further be desirable to provide Combined MWC Ash as the raw material without significant additives typical of conventional ceramic materials, such as clay, feldspar and silica, which typically add to the cost of the resultant ceramic.

### SUMMARY OF THE INVENTION

The present invention is a ceramic, made entirely from combined bottom ash and fly ash obtained from municipal waste fired power plants (“Combined MWC Ash”), and its method of manufacture. In particular, the present invention is a ceramic material made from a precursor mixture including bottom ash particles recovered from a municipal solid waste combustor and fly ash particles recovered from combustion residual gases of a municipal solid waste combustor. In one embodiment, the bottom ash particles are the heavier particles recovered from a combustion chamber of a typical municipal solid waste combustor.

In a preferred embodiment, the precursor mixture comprises 80-90% by weight MWC bottom ash particles and 10-20% by weight MWC fly ash particles, and more preferably, 85% parts by weight bottom ash particles and 15% parts by weight fly ash particles. The resulting ceramic material will have a tensile strength of at least 12,500 PSI, about 12-13% voids and a melting point of about 1,100° C. When densified using known methods to achieve a maximum of 5% voids, the resulting ceramic material will have a tensile strength of at least 25,000 PSI.

The present invention further involves a method or process for manufacturing a technical ceramic from Combined MWC Ash. The process includes the steps of recovering bottom ash particles from a municipal solid waste combustor, recovering fly ash particles from combustion residual gases of a municipal solid waste combustor, mixing the bottom ash particles with the fly ash particles to form a precursor combined ash mixture and casting the combined ash mixture to form the ceramic material. In one embodiment, the bottom ash particles are the heavier particles recovered from a combustion chamber of a municipal solid waste combustor.

In a preferred embodiment, 80-90% by weight bottom ash particles is mixed with 10-20% by weight fly ash particles, and more preferably, 85% by weight bottom ash particles are mixed with 15% by weight fly ash particles to form the precursor combined ash mixture. Also, the precursor combined ash mixture is preferably passed over a screening device to eliminate oversize ash particles and is preferably ground to eliminate any large ash chunks. The precursor combined ash mixture is also preferably dried prior to casting. The drying step can be partially done using recirculated flue gas from a municipal solid waste combustion process. Preferably, the precursor combined ash mixture is also pre-heated to a temperature of 900-1,000° C. prior to casting to evaporate moisture and other contaminants.

The precursor combined ash mixture can be slip casted into a mold, or can be tape casted. In either embodiment, casting preferably takes place at a temperature of about 1,100-1,200° C. for approximately 1.5 hours, during which the combined ash material becomes a liquid. The resulting ceramic material can then be finished to obtain a desired final shape. The finishing steps can include machining, laser cutting, water jet cutting and polishing.

The ceramic made according to the present invention provides a low cost, high strength, high heat resistance ceramic for many industrial applications. No special manufacturing processes are required beyond the established conventional MWC ash processing steps of oversize screening and oversize ferrous and nonferrous metal recovery for recycling. The remaining Combined MWC Ash can then be prepared by typical ceramic processing steps such as grinding, sintering and densification. The present invention thus further simultaneously eliminates the environmental impact of disposing MWC ash waste products from municipal solid waste facilities.

The preferred embodiments of the ceramic products created from Combined MWC Ash, as well as other objects, features and advantages of this invention, will be apparent from the following detailed description, which is to be read in conjunction with the accompanying drawings.

### BRIEF DESCRIPTION OF THE DRAWING

FIG. 1 is a typical processing flow chart for one of many embodiments of Combined MWC Ash ceramic material.

### DETAILED DESCRIPTION OF THE PREFERRED EMBODIMENTS

The inventors have found that the constituents in Combined MWC Ash, which historically had only limited beneficial use applications, have a significant and useful application in the design of a technical ceramic. Namely, the high concentration of glass, the metals content, and the wide range of particle sizes typical in Combined MWC Ash are well suited for the manufacture of ceramic materials. Moreover, the ceramic material using Combined MWC Ash according to the present invention has a reduced manufacturing cost in comparison with conventional ceramic material feedstocks.

Further, it has been found that the inherent variability of Combined MWC Ash can be managed by adjusting the precursor mixture components of MWC bottom ash and fly ash such that the tensile strength properties of the resulting ceramic products are not significantly affected. Thus, the prior art problems associated with assuring close consistency of technical ceramic mixtures can be avoided. Still further, it has been found that the special manufacturing processes typical for many technical ceramics can be avoided with the present invention. Therefore, the total cost of the products produced in accordance with the present invention can be reduced significantly.

The present invention is a technical ceramic material made from Combined MWC Ash materials obtained as a result of the combustion process in a municipal solid waste combustor. The constituents of Combined MWC Ash are bottom ash and fly ash. Briefly, bottom ash refers to the heavier solid ash residue recovered from the lower extremities of a municipal solid waste combustor as a result of the combustion process. In some municipal solid waste combustors, this bottom ash is recovered from the furnace grate of the combustor chamber. In other combustors, such as fluidized-bed type combustors, the bottom ash is recovered from the bed, or other solid ash residue access point. Fly ash, on the other hand, refers to the residual combustion particulate recovered from the combustion residual gases. A typical municipal waste combustor creates such boiler ash by-products, as a result of the combustion process, that must be disposed of.

Because boiler ash typically contains glass-like materials, such as silicon dioxide and calcium dioxide, the inventors have found that Combined MWC Ash makes an ideal raw material for ceramic materials, such as substrates used in solar cells and other products. In particular as shown in Table 1 below, it was found from the chemical composition of typical samples of MWC bottom ash and fly ash obtained from the SEMASS Resource Recovery Facility in Rochester, Mass., which was developed by Energy Answers Corporation (EAC) of Albany, N.Y., that several of the properties could contribute to a ceramic material with high strength and heat resistance. These properties included high fractions of glassy materials, metals, and a wide range of particle sizes that could lead to a material with few voids and therefore high-strength mechanical properties.

TABLE 1

| | Bottom Ash | | | Fly Ash | |
|---|---|---|---|---|---|
| Element | #1 | #2 | #3 | #1 | #2 |
| Silicon | 31.19 | 16.42 | 16.71 | 10.98 | 10.44 |
| Calcium | 23.53 | 54.39 | 51.01 | 36.91 | 40.09 |
| Iron | 21.02 | 5.27 | 7.22 | 3.90 | 2.96 |
| Aluminum | 10.92 | 8.04 | 6.99 | 5.22 | 5.00 |
| Sulfur | 2.86 | 3.83 | 4.20 | 5.83 | 5.56 |
| Chlorine | 1.10 | 2.09 | 2.56 | 22.65 | 23.63 |
| Titanium | 3.51 | 4.29 | 2.93 | 2.61 | 2.82 |
| Copper | 0.90 | 0.00 | 0.00 | 0.00 | 0.00 |
| Magnesium | 0.00 | 1.60 | 2.11 | 0.15 | 0.17 |
| Manganese | 0.48 | 0.00 | 0.47 | 0.00 | 0.00 |
| Zinc | 0.79 | 2.06 | 2.36 | 4.74 | 3.46 |
| Phosphorus | 0.00 | 0.99 | 0.54 | 0.00 | 0.00 |
| Potassium | 1.86 | 1.03 | 1.50 | 3.78 | 3.34 |
| Sodium | 1.85 | 0.00 | 1.40 | 2.23 | 1.52 |
| TOTAL | 100.01 | 100.01 | 100.00 | 99.00 | 98.99 |

It is also evident from Table 1 that the ash constituent percentages vary widely from sample to sample. This is not surprising given that solid waste typically contains inconsistent concentrations of various elements. Adding the various combustion technologies, air pollution control strategies using different reagent additions and the diverse locations of municipal solid waste combustor facilities, it is clear that the composition of the bottom ash and fly ash anticipated for use in the present invention may widely vary in their constituent elements.

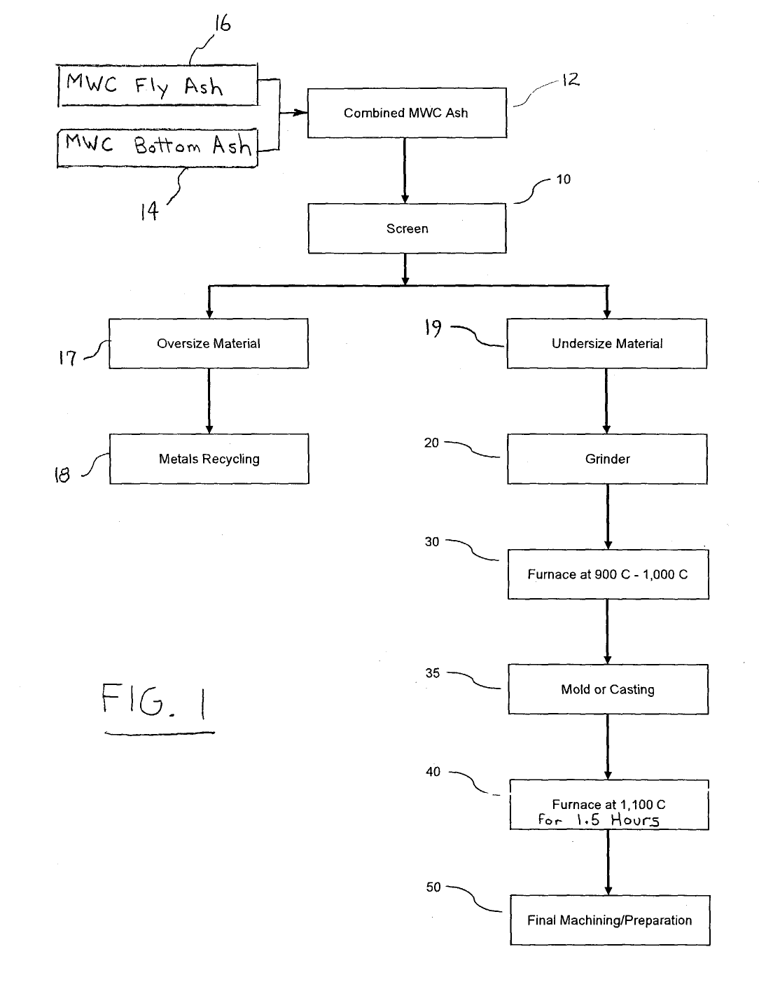

FIG. 1 is a flow chart showing generally the typical steps for making a technical ceramic substrate from Combined MWC Ash, according to the present invention. Conventional MWC ash processing technologies, such as screening and metals separation have been established for many years, but have often been abandoned due to economic disincentives. These technologies can now be applied in conjunction with the present invention for mutual benefit. The initial processing steps would typically be located at the MWC facility, although other embodiments would allow all processing at an adjacent or remote ceramics manufacturing facility.

The optimum ratio by weight of bottom ash to fly ash for producing the ceramic material of the present invention has been found to be approximately 80-90% bottom ash to 10-20% fly ash. More preferably, the precursor ash mixture contains 85% bottom ash and 15% fly ash. It has been found that within this range of weight percentages of bottom ash to fly ash, strength properties of the finished ceramic material are optimized.

Significantly, the optimum ratio of bottom ash to fly ash in the ceramic material of the present invention is roughly equivalent to the ratio actually produced in the operation of a typical MWC facility. Thus, the new class of ceramics according to the present invention has the capability to provide a high-end beneficial use for MWC ash from all 109 facilities currently operating in the United States and hundreds of others around the world. As a result, MWC's could for the first time achieve the long-standing goal of zero disposal of society's wastes.

Still referring to FIG. 1, a Combined MWC Ash mixture 12 of preferably 85% MWC bottom ash 14 and 15% MWC fly ash 16 is passed over a standard screening device in Step 10, wherein the oversize material 17 is primarily ferrous and non-ferrous metal suitable for recycling 18 and the undersize material 19 is suitable for further processing into Combined MWC Ash ceramic materials. Alternatively, the bottom ash 14 only may be screened and the fly ash 16 added to the undersized material 19. Typically, the undersized portion 19 of the Combined MWC Ash material can be delivered to a ceramic manufacturing facility at this point. The undersized combined ash material 19 is then passed through a grinder in Step 20 to eliminate any large chunks. In another alternative, if recirculated flue gas from the MWC combustion process is available for drying the Combined MWC Ash stream, this could be incorporated into grinding Step 20 located at the MWC facility.

The Combined MWC Ash is heated in Step 30 in an electric arc furnace to a temperature of 900° C.-1,000° C. to evaporate moisture and other contaminants. This heating step also helps the Combined MWC Ash to achieve maximum density.

At this point, the Combined MWC Ash material can be slip cast as a “liquid” using established industry techniques into a mold in Step 35 to create complex shapes, or it can be tape cast, also in accordance with established industry procedures, to achieve large surface area parts. In the slip cast scenario, the Combined MWC Ash material is then heated for 1.5 hours at 1,100° C. in Step 40 in the electric arc furnace. This temperature is the glass transition temperature whereby the Combined MWC Ash material is turned into a liquid and many impurities are burned off. Any remaining impurities then become mechanically bound within the hardened ceramic material as it cools. Other embodiments of the present invention may include use of MWC furnace heat rather than a separate electric arc furnace, depending on energy production economics.

Once the molding is complete, the now hardened Combined MWC Ash material is removed from the mold and finishing is accomplished in Step 50. Depending on the final application and product service conditions, finishing can include final machining, laser cutting or water jet cutting to obtain the desired final shape of the product. The inventors have shown that the resulting Combined MWC Ash material can also be polished to a very refined surface for additional industrial applications.

The resulting new class of ceramics, utilizing Combined MWC Ash in the range of 80% to 90% bottom ash mixed with 10% to 20% fly ash, demonstrates a tensile strength of at least 12,500 psi with 12-13% voids and a melting point of 1,100° C. This material has the potential to achieve material strength comparable with aluminum at a similar density, upon elimination of voids according to established industry methods. These properties open the door to dozens of applications in many industries. For example, very thin substrates can be produced to dramatically improve performance and decrease the cost of solar power cells, and large geometries can be produced for a wide range of products, including high temperature electronic assemblies, high voltage insulators, vacuum connectors, and other structural materials.

### EXAMPLE

Initially, separated samples of MWC bottom ash and fly ash with the chemical analysis similar to Table 1 were used. In an effort to identify the optimum mixture of bottom ash and fly ash, a number of samples were prepared using pure bottom ash, pure fly ash, ash mixed with alumina (since alumina is a conventional feedstock for ceramic materials), and various mixtures of bottom ash and fly ash. The mixtures were oven-dried, ball-milled, and screened for good densification by an independent laboratory. The samples were then heated at varying temperatures, cooled, and tested for tensile strength and density.

Many of the resulting materials produced were weak and unstable. However, a mixture of 85% bottom ash and 15% fly ash processed at 1,100° C. for 1.5 hours produced a strong and stable ceramic with an average tensile strength of 12,488 PSI and a density of 2.6 grams per cubic meter. The resulting baseline mechanical properties of several samples are tabulated below in Table 2.

TABLE 2

| | Tensile |
|---|---|
| Sample | Strength, PSI |
| Fly Ash + 10% Alumina | 10,146 |
| Bottom Ash Only | 7,382 |
| 85% Bottom Ash/15% Fly Ash | 12,488 |

As indicated by Table 2, the resulting Combined MWC Ash ceramic material has a tensile strength of about 12,500 PSI with 12%-13% voids. According to published literature and established art in the ceramics field, the final strength of the Combined MWC Ash material can be increased up to 2-2.5 times the already established level, or up to 25,000 PSI-30,000 PSI, by decreasing the voids in the material. This is comparable to T6061 aluminum, which has a tensile strength of 18,000 PSI at about the same density. With a melting point of about 1,100° C., the Combined MWC Ash can be applied in many processes and products requiring high strength, low density, and high heat resistance.

The present invention therefore provides a novel use for what has historically been considered a waste by-product with high disposal cost and environmental liability. The present invention specifies a commonly occurring, relatively heterogeneous, historically difficult to manage material for use in conventional ceramic manufacturing processes. Because the feedstock for Combined MWC Ash ceramic material is based on MWC combustors, the availability of the material is very high.

Although the preferred embodiments of the present invention have been described with reference to the accompanying drawing, it is to be understood that the invention is not limited to those precise embodiments, and that other changes and modifications may be made by one skilled in the art without departing from the scope or spirit of the invention.

What is claimed is:

1. A ceramic material made from a precursor mixture comprising:
bottom ash particles recovered from a municipal solid waste combustor; and
fly ash particles recovered from combustion residual gases of a municipal solid waste combustor.

2. A ceramic material as defined in claim 1, wherein the precursor mixture comprises 80-90% by weight bottom ash particles and 10-20% by weight fly ash particles.

3. A ceramic material as defined in claim 2, wherein the precursor mixture comprises about 85% parts by weight bottom ash particles and about 15% parts by weight fly ash particles.

4. A ceramic material as defined in claim 1, wherein the bottom ash particles are particles recovered from a combustion chamber of a municipal solid waste combustor.

5. A ceramic material as defined in claim 1, having about 12-13% voids before densification and having a tensile strength of at least 12,000 PSI.

6. A ceramic material as defined in claim 1, having about 5% voids after densification and having a tensile strength of at least 25,000 PSI.

7. A ceramic material as defined in claim 1, having a melting point of about 1,100° C.

8. A process for producing a ceramic material comprising the steps of:
recovering bottom ash particles from a municipal solid waste combustor;
recovering fly ash particles from combustion residual gases of a municipal solid waste combustor;
mixing said bottom ash particles with said fly ash particles to form a precursor combined ash mixture; and
casting said combined ash mixture to form said ceramic material.

9. A process for producing a ceramic material as defined in claim 8, wherein the bottom ash particles are particles recovered from a combustion chamber of a municipal solid waste combustor.

10. A process for producing a ceramic material as defined in claim 8, wherein 80-90% by weight bottom ash particles are mixed with 10-20% by weight fly ash particles to form said precursor combined ash mixture.

11. A process for producing a ceramic material as defined in claim 10, wherein about 85% by weight bottom ash particles are mixed with about 15% by weight fly ash particles to form said precursor combined ash mixture.

12. A process for producing a ceramic material as defined in claim 8, further comprising the step of passing said precursor combined ash mixture over a screening device to eliminate oversize ash particles.

13. A process for producing a ceramic material as defined in claim 8, further comprising the step of grinding said precursor combined ash mixture to eliminate any large ash chunks.

14. A process for producing a ceramic material as defined in claim 8, further comprising the step of drying said precursor combined ash mixture prior to casting.

15. A process for producing a ceramic material as defined in claim 14, wherein said precursor combined ash mixture is dried using recirculated flue gas from a municipal solid waste combustion process.

16. A process for producing a ceramic material as defined in claim 8, further comprising the step of pre-heating said precursor combined ash mixture prior to casting to evaporate moisture and other contaminants.

17. A process for producing a ceramic material as defined in claim 16, wherein said precursor combined ash mixture is pre-heated to a temperature of 900-1,000° C.

18. A process for producing a ceramic material as defined in claim 8, wherein said casting step includes the step of slip casting said combined ash mixture into a mold.

19. A process for producing a ceramic material as defined in claim 8, wherein said casting step includes the step of tape casting said combined ash mixture.

20. A process for producing a ceramic material as defined in claim 8, wherein said combined ash material is cast at a temperature of about 1,100-1,200° C. for approximately 1.5 hours.

21. A process for producing a ceramic material as defined in claim 8, wherein said combined ash material becomes a liquid during said casting step.

22. A process for producing a ceramic material as defined in claim 8, further comprising the step of finishing said ceramic material to obtain a desired final shape of said ceramic material.

23. A process for producing a ceramic material as defined in claim 22, wherein said finishing step includes at least one step selected from the group consisting of machining, laser cutting, water jet cutting and polishing.
